(19) United States
(12) Patent Application Publication
(10) Pub. No.: US 2007/0150748 A1
(43) Pub. Date: Jun. 28, 2007

(54) Method of Generating an Artistic Expression Using Biometric Information

(76) Inventor: Lee Hildebrand, Oldsmar, FL (US)

Correspondence Address: SMITH HOPEN, PA, 180 PINE AVENUE NORTH, OLDSMAR, FL, 34677, US

(21) Appl. No.: 11/613,458

(22) Filed: Dec. 20, 2006

Related U.S. Application Data
(60) Provisional application No. 60/753,490, filed on Dec. 23, 2005.

(51) Int. Cl. H04K 1/00

(52) U.S. Cl. 713/186

(57) ABSTRACT

A method of generating an artistic expression from biometric information is provided. Biometric information is obtained from a subject to obtain a numerical value associated with the information, or to establish a seed value. The numerical or seed value comprises a part of the domain for a modification function which is applied to a source object to achieve the artistic expression. In one embodiment, the source object is pre-populated with a plurality of distortion vectors. The distortion vectors identify areas of the source object which can be affected by the modification function.

### CROSS REFERENCE TO RELATED APPLICATIONS

This application claims priority to co-pending U.S. Provisional Application No. 60/753,490, filed Dec. 23, 2005, which is incorporated herein by reference.

### BACKGROUND OF THE INVENTION

Artistic expression is the quintessential application of human creativity and is commonly judged for its appreciative value, usually on the basis of aesthetic value or emotional impact. Several genres of art are grouped by cultural relevance, thereby grouping artist, as well as collectors. Rather than using art to display affiliation with a group, or tribe, many seek to express their individuality through unique artistic expressions. Accordingly, much research, time and money is spent finding art that is unique to the individual.

For example, U.S. Patent Application Publication 2004/0,163,412 describes a method wherein jewelry, such as rings, is adorned with identifying information such as genetic information. This method, however, does not allow users to use personal (i.e. genetic) information to create works of art that are unique yet aesthetically pleasing in that the casual observer does not recognize the artistic representation as containing genetic information.

Similarly, U.S. Patent Application Publication 2004/0,077,648 describes a method of using data associated with genetic information to create images, such as with a fractal algorithm. The information may be altered with a hash algorithm to protect sensitive information. This method creates the entirety of the image from the values associated with the genetic information. Accordingly, it can not be said with any certainty that the resulting image will be aesthetically pleasing to the user.

Therefore, what is needed is a method of using ones biometric (that is truly unique) information to create an artistic expression that is as unique as the individual, while ensuring an aesthetically pleasing result that protects the information used in its creation.

### SUMMARY OF INVENTION

In a general embodiment, the invention provides a method of generating an artistic expression from biometric information. Biometric information is obtained from a subject to establish a seed value. The seed value comprises a part of the domain for a modification function which is applied to a source object to achieve the artistic expression. In one embodiment, the source object is pre-populated with a plurality of distortion vectors. The distortion vectors identify areas of the source object which can be affected by the modification function.

In one embodiment, the biometric information is selected from the group consisting of DNA, fingerprints, retinal scans, iris scans, facial patterns, hand measurements and voice recordings; any means of uniquely identifying a subject can be used. Once the manner of biometric identification is determined, the seed value is expressed as a numeric value corresponding to a pattern of the biometric information. In an alternate embodiment, the seed value is generated by inserting the numeric values corresponding to a pattern of the biometric information into an algorithm selected from the group consisting of genetic algorithms, associative array functions, cryptographic hash functions, hash table functions and geometric hash functions.

Examples of source objects include static images, dynamic images, audio files and text. While this list is illustrative of source objects that can be used with the modification algorithm, any object capable of being represented in a digital format can be used. For example, in cases where the source object is a picture, the modification function can be selected from the group consisting of displacement functions, smoothing functions, fractal functions, warping functions, volumetric interference functions, soft-edge deformation functions, translational displacement functions, rotational displacement functions and data re-fitting functions. Alternatively, where the source object is an audio file, the modification function can be selected from the group consisting of time reversing functions, reordering functions and substitution functions.

### BRIEF DESCRIPTION OF THE DRAWINGS

For a fuller understanding of the nature and objects of the invention, reference should be made to the following detailed description, taken in connection with the accompanying drawings, in which:

FIG. 1 shows an example of results from a common DNA test showing gel electrophoresis results; alleles and repeats are shown.

FIG. 2 shows an example of results from a common DNA test showing peaks associated with alleles at tested chromosomal locations.

FIG. 3 is a block diagram of one embodiment of the invention.

FIG. 4 is a block diagram of alternate embodiment of the invention.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

In use, biometric information in the form of one or more physical characteristics is obtained from a subject. This information is then processed by a numerical algorithm, and entered into a database, thereby creating a digital representation of the obtained biometric. As used herein, the term “biometric information” refers to any physical characteristic capable of uniquely identifying an individual, including but not limited to fingerprints, retinal and iris patterns, facial patterns, hand measurements, the subjects voice as well as the subjects signature, that can be rendered in a digital form or expressed as a numerical value.

In one embodiment, the biometric information is a genetic fingerprint of the subject. The genetic fingerprint, is determined by known DNA testing, DNA typing, and DNA profiling techniques, is used to uniquely identify the subject by exploiting highly variable repeating DNA sequences, called minisatellites, at given loci. Well known methods are commonly used to detect the number of repeats at several loci.

A common procedure for DNA fingerprinting is restriction fragment length polymorphism (RFLP). Although RFLP analysis has been almost largely replaced with newer techniques, this analysis is performed by using a restriction enzyme to cut the subject DNA into fragments which are separated into bands using agarose gel electrophoresis. The bands of DNA are transferred via a technique called Southern blotting from the agarose gel to a nylon membrane treated with a radioactively-labelled DNA probe which binds to certain specific DNA sequences on the membrane. The excess DNA probe is then washed off. An X-ray film placed next to the nylon membrane detects the radioactive pattern. This film is then developed to make a visible pattern of bands called a DNA fingerprint. By using multiple probes targeting various polymorphisms in successive X-ray images, a fairly high degree of discrimination is possible. Other known methods, such as Polymerase Chair Reaction (PCR) analysis, short tandem repeat (STR) analysis, amplified fragment length polymorphism (AmpFLP) analysis, Y-chromosome analysis and mitochondrial DNA (mtDNA) analyis can also be employed.

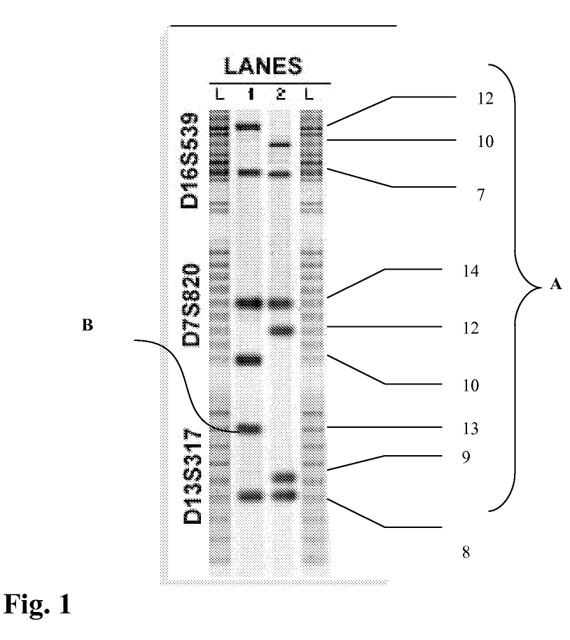

As shown in FIG. 1, the samples are then separated, by various chromatographic methods, by size and represented by a numerical value A (e.g., 9, 10, 11), and referred to as alleles B (See FIG. 1). For example, if the repeating code is CAT, and we see at that marker CATCATCATCAT, then the result is 4. The number of repeats can increase or decrease whenever a mutation either makes an extra copy of the code (CATCATCATCATCAT) or drops a copy (CATCATCAT). The numerical value equates to the number of times the sequence is repeated. If the marker has a value of 10, then the unique sequence of chemicals that defines the marker was repeated 10 times (repeats, alleles).

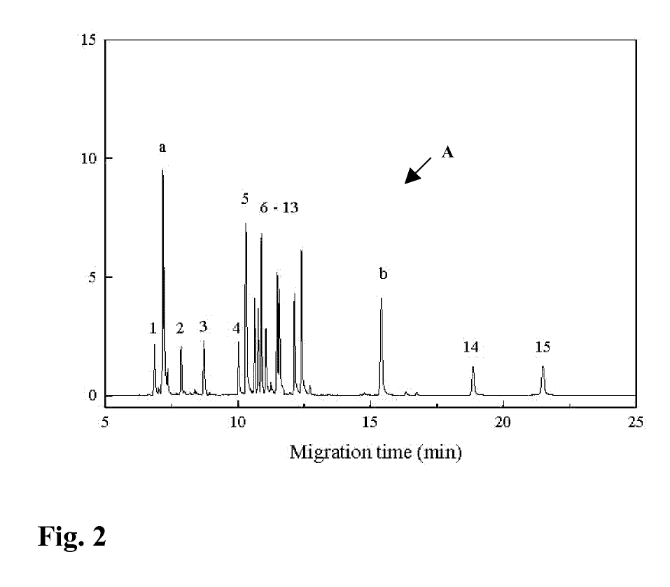

Alternatively an electropherogram, or chromatograph, (FIG. 2) is created showing the peaks B that represent the alleles at each chromosomal location tested for the subject. Peak values B can then be used to assign a unique numeric value for the subject.

In addition to genetic information, physical biometric scanning means are known. For example, U.S. Pat. No. 7,147,153, which is incorporated herein by reference, describes methods and systems for biometric sensing. An illumination subsystem provides light at discrete wavelengths to a skin site of the individual. A detection subsystem receives light scattered from the skin site. A computational unit is interfaced with the detection system. The computational unit has instructions for deriving a spatially distributed multispectral image from the received light at the discrete wavelengths. The computational unit also has instructions for comparing the derived multispectral image with a database of multispectral images to identify the individual. While these described methods and system are illustrative of means capable for use with the invention, any manner of assigning a numerical value to a biometric indicator unique to the individual can be used.

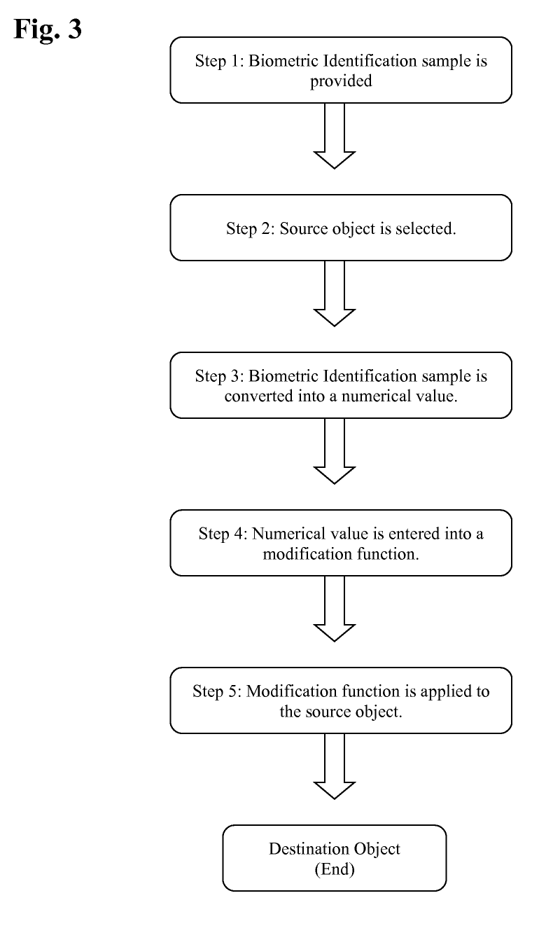

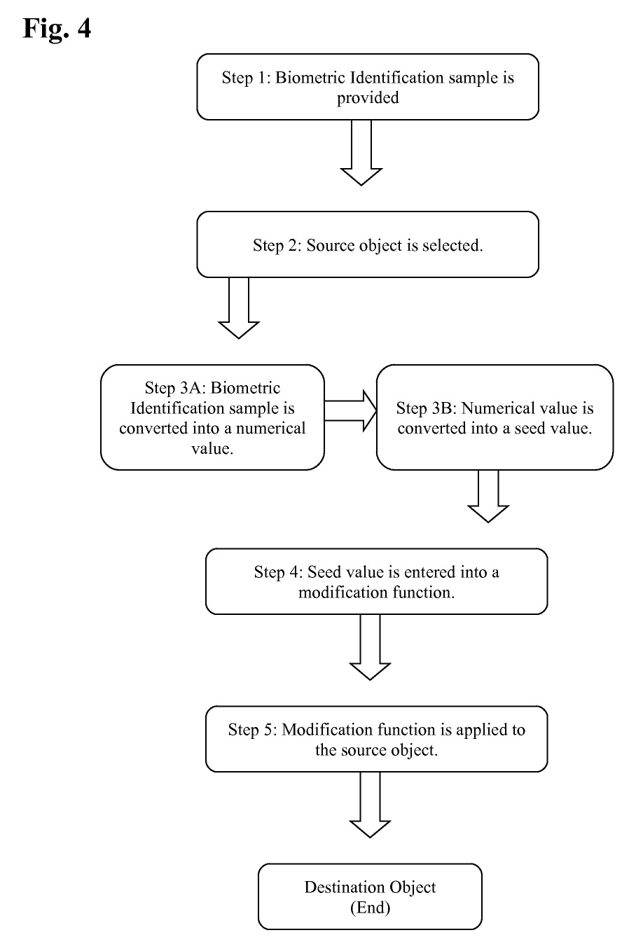

FIGS. 3 and 4 provide an outline of alternate embodiments of the invention. Referring to FIG. 3, in Step 1 the subject provides a form of biometric identification, such as a DNA sample. In Step 2 the subject selects a source object, such as an image or piece of music. In Step 3, the biometric identification is converted into a numerical value. The numerical value associated with the pattern of biometric information is inserted use in a modification function (see Step 4 in FIG. 3). Alternatively, as shown in Steps 3A and 3B in FIG. 4, the numerical value associated with a pattern of the biometric information (Step 3A) can then be used in a predetermined algorithm to determine a seed value (Step 3B). Illustrative algorithms for generating a seed value based on a numerical value associated with a pattern of the biometric information are genetic algorithms, associative array functions, cryptographic hash functions, hash table functions and geometric hash functions. Manipulation of the numerical value associated with the biometric information is preferable in cases where it desirable that the biometric information can be easily read, or deduced, from the final artistic expression.

A modification function is any mathematical function that takes a position, representing data within a source object, within some domain as an input and provides a position, representing data within a destination object, within some range as an output. Modification functions are known in the art. U.S. Pat. No. 6,867,770, which is incorporated herein by reference, describes a system and methods for voxel warping. Similarly, U.S. Pat. No. 7,098,932, incorporated herein by reference, describes a method of applying water reflection and warping effects to an image based on distortion vectors embedded within the image.

Examples of modification functions include displacement functions, smoothing functions, fractal functions, warping functions, volumetric interference functions, soft-edge deformation functions, translational displacement functions, rotational displacement functions and data re-fitting functions. It should be noted, however, that the present invention is not limited to warping or applying the modification function to images; any artistic representation capable of being stored in an electronic medium can be used. Examples of modification functions for use with audio files include time reversing functions, reordering functions and substitution functions.

In Step 5, the modification function is applied to the source object to create the final artistic expression, or destination object. Example source objects include static images, dynamic images, audio files and text. As used herein, the term “source object” includes any artistic representation stored in an electronic medium that is capable of modification by the modification function.

It is possible to associate the source object with a plurality of distortion vectors. A distortion vector includes any position or data within a source object that has been predefined for modification by a modification function. This embodiment allows multiple users, such as couples, to create works of art that are unique but share common elements. This embodiment also allows control over how much of a given source object will be modified by the modification function.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. A method of generating an artistic expression from biometric information, comprising the steps of:
obtaining biometric information from a subject;
establishing a seed value associated with the biometric information;
providing a source object; and
applying a modification function comprising the seed value to the source object.

2. The method of claim 1 wherein the source object is associated with a plurality of distortion vectors.

3. The method of claim 2 wherein one or more of the distortion vectors are modified according to the modification function comprising the seed value.

4. The method of claim 1 wherein the biometric information is selected from the group consisting of DNA, fingerprints, retinal scans, iris scans, facial patterns, hand measurements and voice recordings.

5. The method of claim 4 wherein the seed value is a numeric value corresponding to a pattern of the biometric information.

6. The method of claim 1 wherein the seed value is generated by inserting a numeric values corresponding to a pattern of the biometric information into an algorithm selected from the group consisting of genetic algorithms, associative array functions, cryptographic hash functions, hash table functions and geometric hash functions.

7. The method of claim 1 wherein the source object is selected from the group consisting of static images, dynamic images, audio files and text.

8. The method of claim 1 wherein the modification function is selected from the group consisting of displacement functions, smoothing functions, fractal functions, warping functions, volumetric interference functions, soft-edge deformation functions, translational displacement functions, rotational displacement functions and data re-fitting functions.

9. The method of claim 1 wherein the modification function is selected from the group consisting of time reversing functions, reordering functions and substitution functions.

10. Method of generating an artistic expression from biometric information, comprising the steps of:
obtaining biometric information from a subject;
establishing a numeric value corresponding to a pattern of the biometric information;
providing a source object associated with a plurality of distortion vectors; and
applying a modification function to the source object;
whereby one or more of the distortion vectors are modified according to the modification function.

11. The method of claim 10 wherein the biometric information is selected from the group consisting of DNA, fingerprints, retinal scans, iris scans, facial patterns, hand measurements and voice recordings.

12. The method of claim 10 wherein the domain of the modification function comprises a seed value.

13. The method of claim 12 wherein a seed value is generated by inserting the numeric value corresponding to a pattern of the biometric information into an algorithm selected from the group consisting of genetic algorithms, associative array functions, cryptographic hash functions, hash table functions and geometric hash functions.

14. The method of claim 10 wherein the source object is selected from the group consisting of static images, dynamic images, audio files and text.

15. The method of claim 10 wherein the modification function is selected from the group consisting of displacement functions, smoothing functions, fractal functions, warping functions, volumetric interference functions, soft-edge deformation functions, translational displacement functions, rotational displacement functions and data re-fitting functions.

16. The method of claim 10 wherein the modification function is selected from the group consisting of time reversing functions, reordering functions and substitution functions.

17. Method of generating an artistic expression from biometric information, comprising the steps of:
obtaining biometric information selected from the group consisting of DNA, fingerprints, retinal scans, iris scans, facial patterns, hand measurements and voice recordings;
establishing a numeric value corresponding to a pattern of the biometric information;
providing a source object associated with a plurality of distortion vectors, selected from the group consisting of static images, dynamic images, audio files and text; establishing a modification function, wherein the domain of the modification function comprises a seed value generated by inserting the numeric value corresponding to a pattern of the biometric information into an algorithm selected from the group consisting of genetic algorithms, associative array functions, cryptographic hash functions, hash table functions and geometric hash functions;
applying a modification function to the source object;
whereby one or more of the distortion vectors are modified according to the modification function.

18. The method of claim 10 wherein the modification function is selected from the group consisting of displacement functions, smoothing functions, fractal functions, warping functions, volumetric interference functions, soft-edge deformation functions, translational displacement functions, rotational displacement functions and data re-fitting functions.

19. The method of claim 10 wherein the modification function is selected from the group consisting of time reversing functions, reordering functions and substitution functions.
